(19) United States
(12) Patent Application Publication
(10) Pub. No.: US 2006/0218785 A1
(43) Pub. Date: Oct. 5, 2006

(54) Method of producing heat-resistant electrically charged resin material, electret condenser microphone using the heat-resistant electrically charged resin material, and method of producing the same

(76) Inventors: Megumi Horiuchi, Fujiyoshida-shi (JP); Yuki Tsuchiya, Fujiyoshida-shi (JP); Keiji Watanabe, Fujiyoshida-shi (JP)

Correspondence Address: BRINKS HOFER GILSON & LIONE, P.O. BOX 10395, CHICAGO, IL, 60610, US

(21) Appl. No.: 11/395,000

(22) Filed: Mar. 30, 2006

(30) Foreign Application Priority Data
Mar. 31, 2005 (JP) JP2005-100358

(51) Int. Cl. H01B 19/00

(52) U.S. Cl. 29/886

(57) ABSTRACT

A fluororesin material is irradiated with ionizing radiation at a temperature not lower than the crystalline melting point of the fluororesin material in the absence of oxygen to form a crosslinked modified fluororesin material. An electric charge is implanted into the modified fluororesin material to provide a heat-resistant electrically charged resin material suitable for use as an electret element of an electret condenser microphone or the like.

This application claims priority under 35 U.S.C. § 119 to Japanese Patent Application No. JP2005-100358 filed Mar. 31, 2005, the entire content of which is hereby incorporated by reference.

### BACKGROUND OF THE INVENTION

1. Field of the Invention

The present invention relates to a method of producing a heat-resistant electrically charged resin material (electrically charged resin material will hereinafter occasionally be referred to as simply “charged resin material”) and also relates to an electret condenser microphone using the heat-resistant charged resin material, which is widely usable as a consumer microphone, for example, in portable cellular phones, videocameras, digital cameras, and personal computers, and a method of producing the electret condenser microphone.

2. Description of the Related Art

An electret condenser microphone, for example, is known as an electrical product using a charged resin material.

A conventional electret condenser microphone is disclosed, for example, in Japanese Patent Application Publication No. 2002-345087. The electret condenser microphone has a diaphragm and an electret that are opposed to each other. The electret is formed by permanently electrifying (electrically charging) a resin material. When sound causes the diaphragm to vibrate, the capacitance between the diaphragm and the electret changes, and the change in capacitance is taken out as an electric signal.

When an electret condenser microphone is used in a device, e.g. a cellular phone, it is mounted on a circuit board (motherboard) of the device. It is desirable from the viewpoint of packaging cost that the electret condenser microphone be surface-mountable on the circuit board. To perform surface mounting, however, the electret condenser microphone needs to be placed on the circuit board and put into a reflow oven, in which it is subject to preheating at about 150° C. to 200° C. for 90 to 120 seconds, followed by heating at a high temperature of 230° C. to 260° C. for 10 seconds. Under the high-temperature conditions, the electric charge in the electret layer will discharge or decay, so that the electret condenser microphone becomes unable to perform its function as a microphone.

Some propositions have heretofore been made to solve the above-described problem. For example, Published Japanese Translation of PCT International Publication for Patent Application No. 2001-518246 discloses an electret condenser microphone that uses silicon, i.e. an inorganic material, as an electret material in place of an organic charged resin material, which is problematic in terms of heat resistance. The electret using silicon is free from the problem of heat resistance and allows surface mounting of an electret condenser microphone in a reflow oven. This electret suffers, however, from an increase in cost.

Japanese Patent Application Publication No. 2000-32596 discloses a method of producing an electret condenser microphone of high heat resistance. According to the disclosed method, a backplate substrate is prepared by fusion-bonding a resin material for constituting an electret layer to a metal substrate. The backplate substrate is subject to high-temperature annealing at about 200° C. for about 1 to 6 hours, followed by electric charge implantation, thereby constructing a high heat-resistant electret condenser microphone.

Meanwhile, Japanese Patent No. 3317452 discloses a modified fluororesin, although this is not directly concerned with an electret condenser microphone. According to this patent, a fluorine-containing resin material, e.g. polytetrafluoroethylene (hereinafter abbreviated as “PTFE”), fluorinated ethylene-propylene copolymer (hereinafter abbreviated as “FEP”), or tetrafluoroethylene-perfluoroalkyl vinyl ether copolymer (hereinafter abbreviated as “PFA”), is irradiated with a predetermined dose of ionizing radiation at a temperature not lower than the crystalline melting point of the resin material in the absence of oxygen, thereby changing the resin material into a crosslinked modified fluororesin. Japanese Patent Application Publication No. Hei 11-49867 discloses a crosslinked modified fluororesin produced by irradiating FEP with a predetermined dose of ionizing radiation at a temperature in the neighborhood of the crystalline melting point of the FEP in the absence of oxygen.

These techniques concerning modified fluororesin were developed to improve fluororesin, which cannot be used under radiation environment, e.g. in nuclear power facilities as fluororesin has a radiation-degradable molecular structure while it is excellent in heat resistance and chemical resistance and widely used for industrial and household purposes. According to the above-described techniques, fluororesin is irradiated with ionizing radiation to effect crosslinking, thereby markedly improving heat resistance and mechanical properties under radiation environment.

The present applicant took notice of the modified fluororesin crosslinked by irradiation with ionizing radiation, which is disclosed in Japanese Patent No. 3317452 and Japanese Patent Application Publication No. Hei 11-49867.

That is, in view of the fact that the crosslinked modified fluororesin exhibits high heat-resistance characteristics under adverse environment, e.g. radiation environment, we assumed that if a charged resin material obtained by electrically charging the modified fluororesin is used as an electret layer, the decay of electric charge under the reflow conditions can be effectively prevented.

### SUMMARY OF THE INVENTION

Accordingly, an object of the present invention is to provide a method of producing a heat-resistant electrically charged resin material capable of coping with the high temperature of the reflow mounting process, which has heretofore been regarded as difficult, by applying the above-described ionizing radiation irradiation technique.

Another object of the present invention is to provide an electret condenser microphone using the above-described heat-resistant electrically charged resin material.

That is, the present invention provides a method of producing a heat-resistant electrically charged resin material, which includes the steps of: providing a fluororesin material; irradiating the fluororesin material with ionizing radiation at a temperature not lower than the crystalline melting point of the fluororesin material in the absence of oxygen, thereby changing the fluororesin material into a crosslinked modified fluororesin material; and implanting an electric charge into the modified fluororesin material.

Specifically, the fluororesin material may be one selected from the group consisting of polytetrafluoroethylene, fluorinated ethylene-propylene copolymer, and tetrafluoroethylene-perfluoroalkyl vinyl ether copolymer, and may be in the form of sheet, film, or fibers. The fluororesin material may be irradiated with 10 kGy to 100 kGy of ionizing radiation under the conditions that the temperature is in the range of 280° C. to 330° C. and the oxygen concentration is not higher than 100 ppm. The modified fluororesin material may be subject to the electric charge implantation so as to carry a negative electric charge. The fluororesin material may be a film layer formed on a substrate of a metal or a resin or a ceramic material.

In addition, the present invention provides an electret condenser microphone having an electret layer. The electret layer is formed of a heat-resistant electrically charged resin material prepared by implanting an electric charge into a modified fluororesin material crosslinked by irradiating a fluororesin material with ionizing radiation at a temperature not lower than the crystalline melting point of the fluororesin material in the absence of oxygen. The fluororesin material may be one selected from the group consisting of polytetrafluoroethylene, fluorinated ethylene-propylene copolymer, and tetrafluoroethylene-perfluoroalkyl vinyl ether copolymer.

In addition, the present invention provides a method of producing an electret condenser microphone having a diaphragm, a spacer, an electret layer, and a backplate. The method includes the steps of: forming a resin layer of a fluororesin on the backplate; irradiating the resin layer with ionizing radiation at a temperature not lower than the crystalline melting point of the fluororesin in the absence of oxygen, thereby changing the resin layer into a crosslinked modified fluororesin layer; and implanting an electric charge into the modified fluororesin layer to form the electret layer.

Specifically, the method may include the steps of: providing an electric circuit board assembly in which a multiplicity of electric circuit boards having semiconductor and other electric elements mounted thereon are integrally arrayed in a matrix; providing a backplate substrate assembly in which a multiplicity of backplate substrates each having the backplate are integrally arrayed in a matrix; forming a resin layer of a fluororesin on each backplate of the backplate substrate assembly; irradiating the resin layer with ionizing radiation at a temperature not lower than the crystalline melting point of the fluororesin in the absence of oxygen, thereby forming a crosslinked modified fluororesin layer; implanting an electric charge into the modified fluororesin layer to form the electret layer; providing a spacer assembly in which a multiplicity of spacers are integrally arrayed in a matrix; providing a diaphragm unit assembly in which a multiplicity of diaphragm support frames are integrally arrayed in a matrix and a diaphragm material is spread on one side thereof; bonding these assemblies to form a stacked assembly; and cutting the stacked assembly into individual electret condenser microphones.

Another specific example of the method may include the steps of: providing an electric circuit board assembly in which a multiplicity of electric circuit boards having semiconductor and other electric elements mounted thereon are integrally arrayed in a matrix; providing a backplate substrate assembly in which a multiplicity of backplate substrates each having the backplate are integrally arrayed in a matrix; irradiating a resin sheet of a fluororesin with ionizing radiation at a temperature not lower than the crystalline melting point of the fluororesin in the absence of oxygen, thereby forming a crosslinked modified fluororesin sheet; die-cutting the modified fluororesin sheet to form an electret material; integrally stacking the electret material on each backplate of the backplate substrate assembly to form the electret layer; implanting an electric charge into the electret layer; providing a spacer assembly in which a multiplicity of spacers are integrally arrayed in a matrix; providing a diaphragm unit assembly in which a multiplicity of diaphragm support frames are integrally arrayed in a matrix and a diaphragm material is spread on one side thereof; bonding these assemblies to form a stacked assembly; and cutting the stacked assembly into individual electret condenser microphones.

In the above-described methods, the fluororesin may be one selected from the group consisting of polytetrafluoroethylene, fluorinated ethylene-propylene copolymer, and tetrafluoroethylene-perfluoroalkyl vinyl ether copolymer. The fluororesin may be irradiated with 10 kGy to 100 kGy of ionizing radiation under the conditions that the temperature is in the range of 280° C. to 330° C. and the oxygen concentration is not higher than 100 ppm.

Thus, the present invention can provide a heat-resistant electrically charged resin material capable of withstanding high-temperature processing. Therefore, it is possible to realize an electret condenser microphone capable of reflow mounting, which is a market need, by using an organic electret material, for example. The present invention only needs to add the ionizing radiation irradiation step to the conventional production process. Therefore, the electret condenser microphone can be produced with high productivity without the need to substantially alter the conventional production process.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a process flow chart showing a method of producing a heat-resistant charged resin material according to a first embodiment of the present invention.

FIG. 2 is a sectional view of an electret condenser microphone according to the present invention.

FIG. 3 is an exploded perspective view of the electret condenser microphone shown in FIG. 2.

FIG. 4 is a perspective view of constituent elements used in an electret condenser microphone producing method according to the present invention.

FIG. 5 is a perspective view of a microphone assembly formed by stacking the constituent elements shown in FIG. 4.

FIG. 6 is a perspective view of individual electret condenser microphones formed by cutting the microphone assembly shown in FIG. 5.

FIG. 7 is a characteristic chart showing heat-resistance characteristics of FEP as an electret layer.

FIG. 8 is a process flow chart showing a method of producing an electret condenser microphone according to a second embodiment of the present invention.

FIG. 9 is a process flow chart showing a method of producing an electret condenser microphone according to a third embodiment of the present invention.

### DESCRIPTION OF THE PREFERRED EMBODIMENTS

Embodiments of the present invention will be explained below with reference to the accompanying drawings.

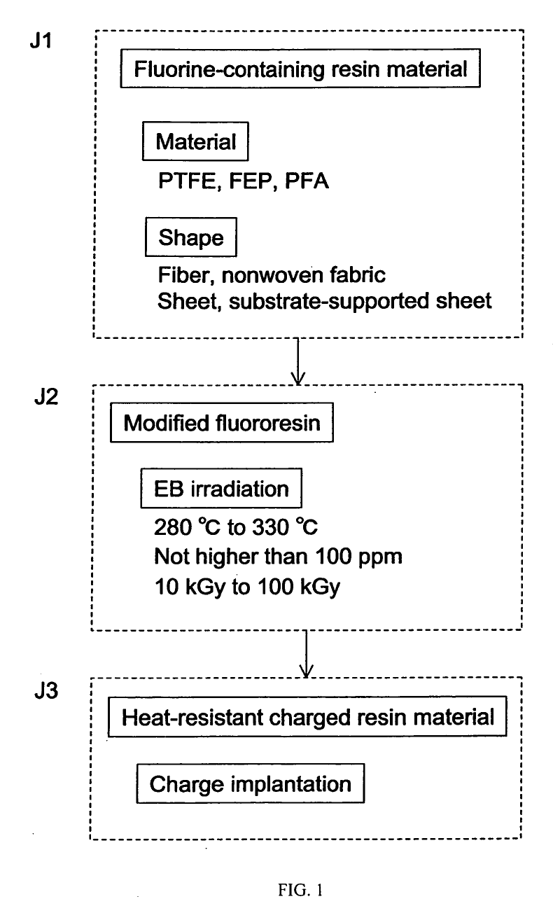

FIG. 1 is a process flow chart showing a method of producing a heat-resistant charged resin material according to a first embodiment of the present invention. According to the production method, a sheet-shaped fluorine-containing resin material, e.g. PTFE, FEP, or PFA, is formed (step J1). Next, the fluorine-containing resin material is irradiated with ionizing radiation to change it into a crosslinked modified fluororesin (step J2). Next, the crosslinked modified fluororesin is subject to electric charge implantation to form a heat-resistant charged resin material (step J3).

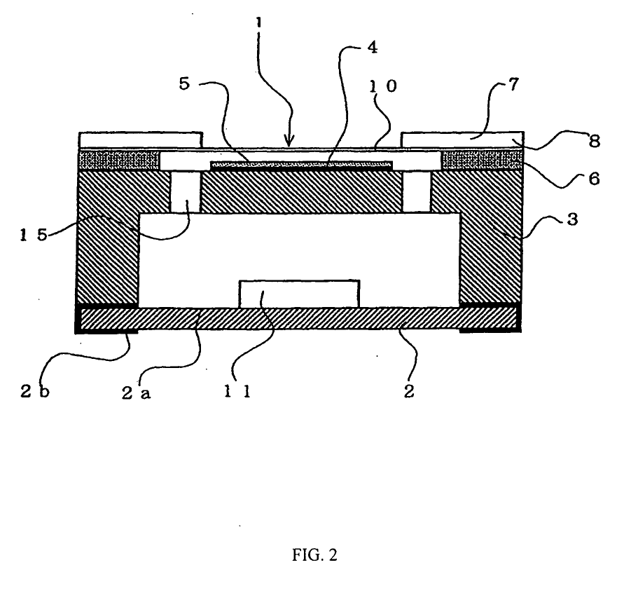

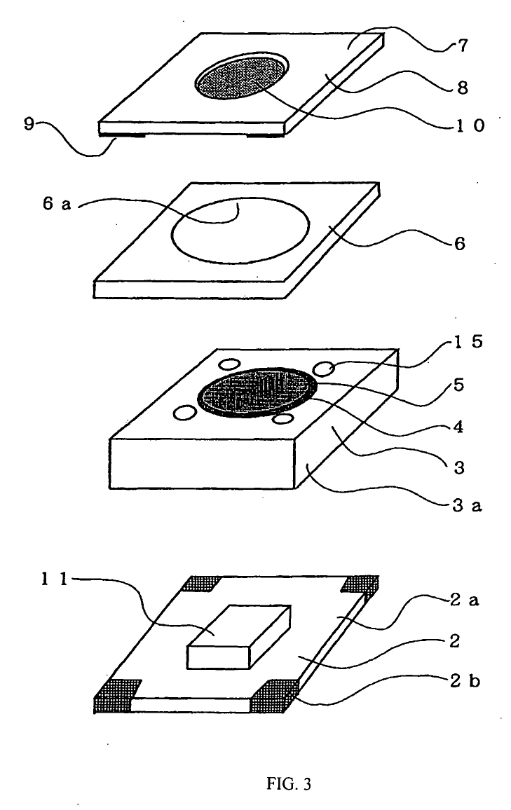

FIGS. 2 and 3 show one embodiment of an electret condenser microphone, which is a typical product using the heat-resistant charged resin material according to the present invention. FIG. 2 is a sectional view of an electret condenser microphone using the heat-resistant charged resin material of the present invention as an electret layer. FIG. 3 is an exploded perspective view of each element constituting the electret condenser microphone shown in FIG. 2.

In FIG. 3, a circuit board 2 comprises an insulating substrate 2a on which connecting terminals 2b are formed. In addition, an integrated circuit 11, which is an electronic component, is mounted on the insulating substrate 2a. A backplate substrate 3 has a recess for accommodating the integrated circuit 11. The backplate substrate 3 is mounted so as to cover the upper side of the circuit board 2 and accommodate the integrated circuit 11 in the recess. A backplate 4 is formed on the upper side of the backplate substrate 3 mounted on the circuit board 2. An electret layer 5 is formed on the upper side of the backplate 4. In addition, a plurality of holes 15 are provided at respective positions on the upper side of the backplate substrate 3 where the holes 15 overlap neither the backplate 4 nor the electret layer 5. A spacer 6 has an opening 6a. A diaphragm unit 7 has a diaphragm support frame 8 formed from an insulating substrate. The diaphragm support frame 8 has terminals 9 formed on the lower side thereof. An electrically conductive diaphragm 10 is secured to the terminals 9, thereby being integrated with the diaphragm support frame 8 into one unit. It should be noted that the integrated circuit 11, the backplate 4, the electret layer 5, the opening 6a of the spacer 6, and the diaphragm 10 are aligned on the same axis. The electret layer 5 and the diaphragm 10 are opposed to each other through the opening 6a.

The backplate substrate 3 has a backplate 4 formed on the upper side thereof. A sheet material with a thickness of 12.5 μm or 25 μm made of FEP, which is a fluorine-containing resin material, is thermocompression-bonded to the upper side of the backplate 4 at a temperature of about 150° C., thereby forming an FEP film. In this state, the backplate substrate 3 is loaded into ionizing radiation irradiation equipment.

In the ionizing radiation irradiation equipment, the backplate substrate 3 is irradiated with ionizing radiation at a dose of about 10 kGy to 100 kGy with an electron beam (EB) intensity of 100 keV to 600 keV in an atmosphere of about 300° C., which is not lower than the crystalline melting point of the FEP, in the absence of oxygen, i.e. at an oxygen concentration not higher than 100 ppm, thereby changing the FEP into a crosslinked modified fluororesin.

Further, the backplate substrate 3 is loaded into charge implantation equipment to implant an electric charge into the modified fluororesin, thereby completing a heat-resistant charged resin material. The heat-resistant charged resin material forms an electret layer 5 to complete a backplate substrate 3 having excellent heat resistance.

The above-described constituent elements, i.e. the circuit board 2, the backplate substrate 3, the spacer 6, and the diaphragm unit 7, are stacked with an adhesive interposed between each pair of adjacent elements, as shown in FIG. 2, thereby completing an electret condenser microphone 1.

To mount the completed electret condenser microphone 1 onto a motherboard of a portable cellular phone or other device, the output terminals 2b of the electret condenser microphone 1 are placed on the motherboard and preheated in a reflow oven at about 150° C. to 200° C. for 90 seconds to 120 seconds, followed by high-temperature processing at a temperature not lower than 230° C. for about 10 seconds. Despite the high-temperature processing, there is a minimal discharge of the electric charge implanted in the electret layer 5, which is formed of the above-described heat-resistant charged resin material, as will be stated later. Accordingly, the electret condenser microphone 1 can function as desired without any problem.

In the electret condenser microphone 1 having the above-described structure, the diaphragm 10 having an electrically conductive film on the surface thereof and the backplate 4 having the electret layer 5 formed on the surface thereof are opposed to each other with the spacer 6 interposed therebetween to form a capacitor. When the diaphragm 10 is vibrated by sound or the like, the capacitance of the capacitor changes, and the change in capacitance is taken out to the circuit board 2 from the diaphragm terminals 9 as a change in voltage. After being processed in the integrated circuit 11, the voltage signal is output from the output terminals 2b of the circuit board 2. The through-holes 15 are provided to smooth the movement of the diaphragm 10.

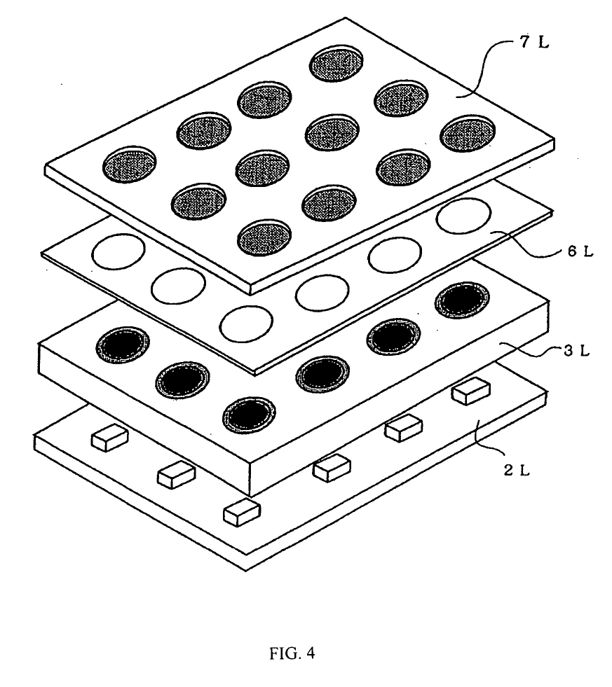

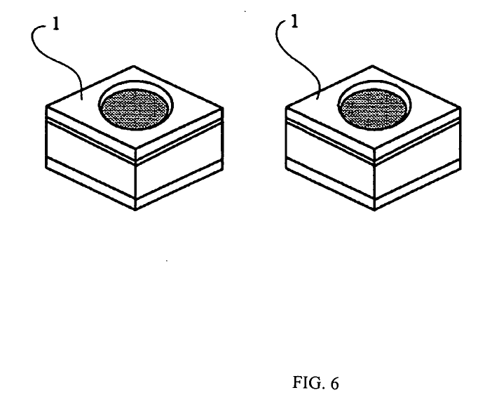

FIGS. 4 to 6 and 8 show a method of producing the above-described electret condenser microphone 1.

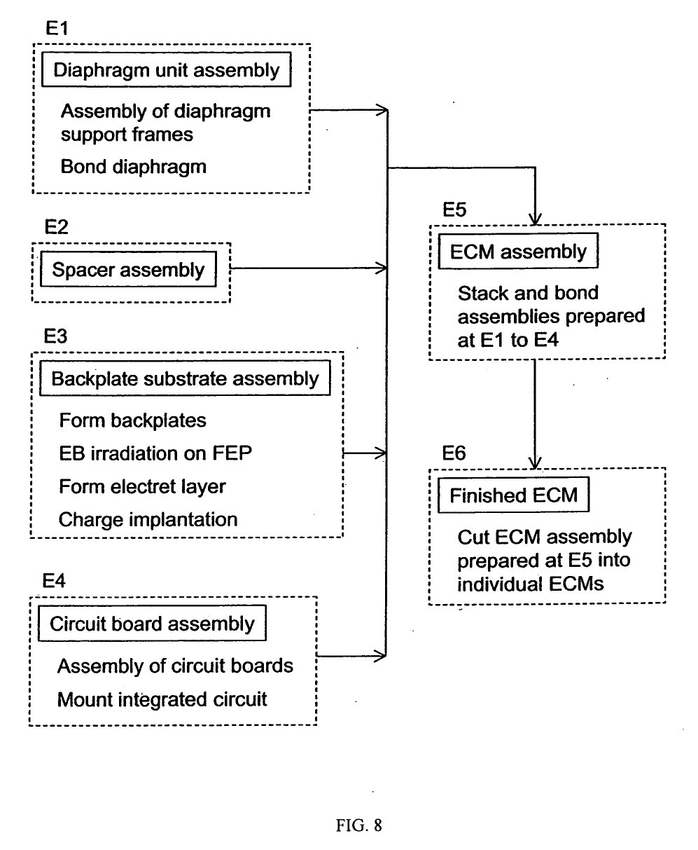

As shown in FIGS. 4 and 8, the production method includes the step of providing a diaphragm unit assembly 7L that is an assembly of diaphragm units 7 as shown in FIG. 3, a spacer assembly 6L that is an assembly of spacers 6 as shown in FIG. 3, a backplate substrate assembly 3L that is an assembly of backplate substrates 3 as shown in FIG. 3, and a circuit board assembly 2L that is an assembly of circuit boards 2 as shown in FIG. 3. These assemblies are stacked and bonded to each other.

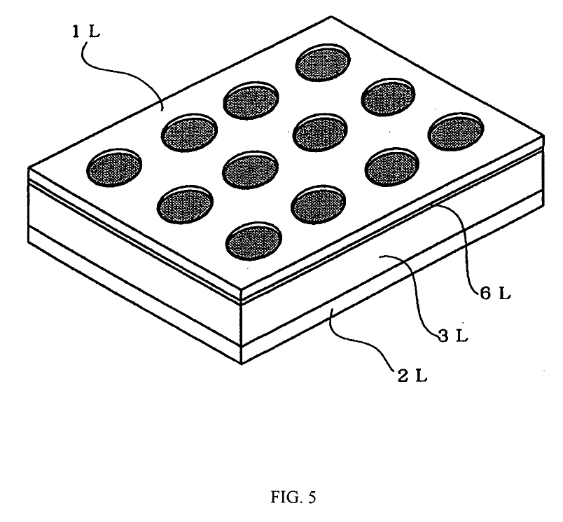

FIG. 5 shows a microphone assembly 1L obtained by stacking and bonding the above-described assemblies. The microphone assembly 1L has a multiplicity (12 in the illustrated example) of electret condenser microphones 1 each comprising a stack of one diaphragm unit of the diaphragm unit assembly 7L, one spacer of the spacer assembly 6L, one backplate substrate of the backplate substrate assembly 3L, and one circuit board of the circuit board assembly 2L. In the microphone assembly 1L, each electret condenser microphone 1 has an integrated circuit 11, a backplate 4, an electret layer 5, a spacer opening 6a, and a diaphragm 10, which are aligned on the same axis. The microphone assembly 1L is cut with a cutter, thereby producing individual divided electret condenser microphones 1.

FIGS. 4 and 5 show a microphone assembly having 12 electret condenser microphones arrayed in a matrix of 3 rows and 4 columns for the sake of explanation. In actuality, however, the microphone assembly is prepared as including several hundreds of electret condenser microphones.

More specifically, as shown in FIG. 8, the diaphragm unit assembly 7L shown in FIG. 4 is prepared as an assembly of diaphragm support frames 8 of diaphragm units 7, and an electrically conductive diaphragm is bonded to one side of the assembly of diaphragm support frames 8.

The backplate substrate assembly 3L is prepared as follows. First, a plurality of recesses are formed in the backplate substrate assembly 3L, and a backplate 4 and an electret layer 5 are provided on the outer upper side of each recess. The electret layer 5 is formed of the fluororesin on the backplate 4. Next, in the ionizing radiation irradiation equipment, the fluororesin of the electret layer 5 is changed into a crosslinked modified fluororesin by irradiation with ionizing radiation at a dose of about 10 kGy to 100 kGy in an atmosphere of 300° C., which is not lower than the crystalline melting point of the FEP constituting the electret layer 5, in the absence of oxygen, i.e. with an oxygen concentration not higher than 100 ppm. Further, in the charge implantation equipment, an electric charge is implanted into the electret layer 5, whereby the backplate substrate assembly 3L is completed.

The circuit board assembly 2L is formed by mounting connecting terminals 2b and integrated circuits 11 on a wiring board assembly as an assembly of circuit boards 2 by using through-holes and the like.

The following is an explanation of the conditions and effects of the above-described radiation irradiation processing performed on the electret layer 5 formed on the backplate substrate 3 and the backplate substrate assembly 3L.

Table 1 below shows the results of a heat resistance test on samples prepared under different conditions of radiation irradiation processing performed on FEP as an electret material used in the present invention. The heat resistance test was performed in consideration of the temperature of the reflow process when the electret condenser microphone is mounted on the motherboard of a device, e.g. a portable cellular phone.

As shown in Table 1, 9 different kinds of samples (FEP) shown by sample symbols A1 to C3 were irradiated with ionizing radiation at 3 different temperatures, i.e. 260° C., 280° C., and 300° C. and at 3 different levels of radiation irradiation dose, i.e. 10 kGy, 50 kGy, and 100 kGy. The temperature conditions were set not higher than 300° C. because at a temperature higher than 300° C. FEP is softened and deformed to a considerable extent, which may give rise to a problem in manufacture. The sample D is shown for comparison, which is a sample not subjected to radiation irradiation.

The charge residual ratio (%) shown in Table 1 below was calculated as follows. Each sample was placed on a hot plate at 200° C., and the surface potential was measured at each elapsed time. The charge residual ratio was calculated from the decrement of the surface potential. The charge residual ratio is used to show the effect of the ionizing radiation irradiation. During the process of heating each sample with the hot plate, the charge residual ratio was measured at an interval of 1 minute from the initiation of the heating to a heating time of 5 minutes in view of the time period at which the electret layer is exposed to high temperature during reflow process, i.e. from 2 to 3 minutes. In addition, assuming more severe conditions, we measured the charge residual ratio when 10 minutes had elapsed from the initiation of the heating.

TABLE 1
EB Processing and Heat Resistance Test

| EB | | | | | | | | | |
|---|---|---|---|---|---|---|---|---|---|
| processing | | | | | | | | | Sam- |
| conditions | | Charge residual ratio (%) | | | | | | | ple |
| Temp. | Dose | Ini- | 1 | 2 | 3 | 4 | 5 | 10 | sym- |
| ° C. | kGy | tial | min | min | min | min | min | min | bol |
| 260 | 10 | 100.0 | 78.6 | 66.0 | 59.7 | 54.2 | 50.8 | 38.2 | A1 |
| | 50 | 100.0 | 70.1 | 55.4 | 48.1 | 45.5 | 41.6 | 29.9 | A2 |
| | 100 | 100.0 | 66.8 | 52.5 | 59.7 | 37.0 | 20.2 | 21.8 | A3 |
| 280 | 10 | 100.0 | 83.9 | 79.1 | 73.9 | 70.4 | 67.4 | 57.4 | B1 |
| | 50 | 100.0 | 86.1 | 78.1 | 73.4 | 70.5 | 67.5 | 56.1 | B2 |
| | 100 | 100.0 | 89.2 | 84.8 | 81.6 | 77.1 | 73.1 | 62.3 | B3 |
| 300 | 10 | 100.0 | 91.2 | 89.8 | 87.4 | 85.6 | 83.7 | 76.7 | C1 |
| | 50 | 100.0 | 91.5 | 89.2 | 86.5 | 84.8 | 83.4 | 75.3 | C2 |
| | 100 | 100.0 | 89.4 | 85.5 | 80.4 | 77.4 | 74.9 | 63.4 | C3 |

| | | | | |
|---|---|---|---|---|
| Unprocessed | 100.0 | 23.1 | 9.9 | D |

[Heat Resistance Test]

Each sample was placed on a hot plate at 200° C., and the surface potential was measured at each elapsed time, thereby calculating the charge residual ratio.

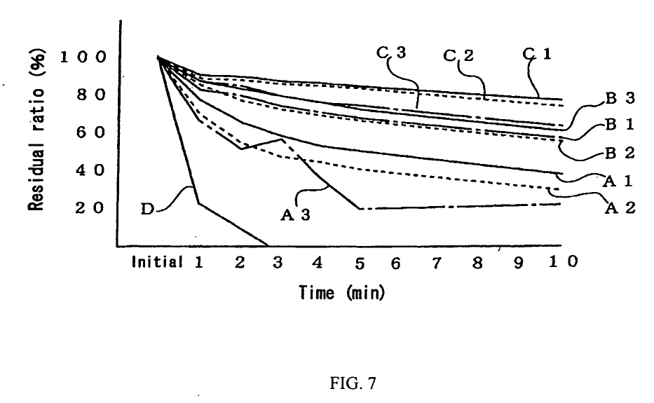

FIG. 7 is a characteristic chart showing heat-resistance characteristics of FEP, which illustrates the results of the test shown in Table 1. As shown in FIG. 7, the residual ratio of electric charge in the unprocessed sample, which is denoted by sample symbol D, reduced to about ¼ at an elapsed time of 1 minute after the heating, to about 1/10 at an elapsed time of 2 minutes, and to zero at an elapsed time of 3 minutes. In contrast, all the samples A, B and C, which were subject to the radiation irradiation processing, kept the electric charge remaining therein even when 10 minutes had elapsed. Thus, it is clear that the radiation irradiation processing is effective in allowing the electric charge to remain in the electret layer of FEP.

Let us compare the effect of radiation irradiation for each irradiation condition. Regarding the temperature condition, it will be understood that the samples C, which were heated to 300° C., are the best; the samples B, which were heated to 280° C., are the second best; and the samples C, which were heated to 260° C., are the third best. Regarding the irradiation dose, it will be understood that, although the samples B show somewhat different results, 10 kGy is the best for the samples A and C, and 50 kGy is the second best but fairly good, and that 100 kGy is the third best and slightly inferior to 10 kGy and 50 kGy.

In view of the above-described reflow temperature, the samples C1 and C2 are the best, and the samples C3 and B3 are the second best. That is, these samples exhibit a charge residual ratio of 80% or more after elapse of 2 to 3 minutes, which is considered to be a time period at which the electret layer is exposed to high temperature during reflow process. The sample B3, however, may be ignored because it tends to show somewhat abnormal values. Thus, it will be understood that a temperature of 300° C. and an irradiation dose of 10 kGy to 50 kGy are particularly suitable as radiation irradiation conditions. If consideration is given to the performance expected for the electret condenser microphone and the allowance for deformation of the electret layer, however, the electret layer may be irradiated with ionizing radiation at a temperature of 280° C. to 330° C. and an irradiation dose of 10 kGy to 100 kGy.

Further, each sample was subject to a humidity resistance test under an environment of 60° C. and 95% in humidity. For all the samples, the charge residual ratio after they had been allowed to stand for 60 hours was 95% to 97%, and the charge residual ratio after the samples had been allowed to stand for 300 hours was 93% to 95%. Thus, there was no problem in terms of humidity resistance.

Although FEP is used as a fluorine-containing resin material in this embodiment, the same results were obtained also for PTFE and PFA.

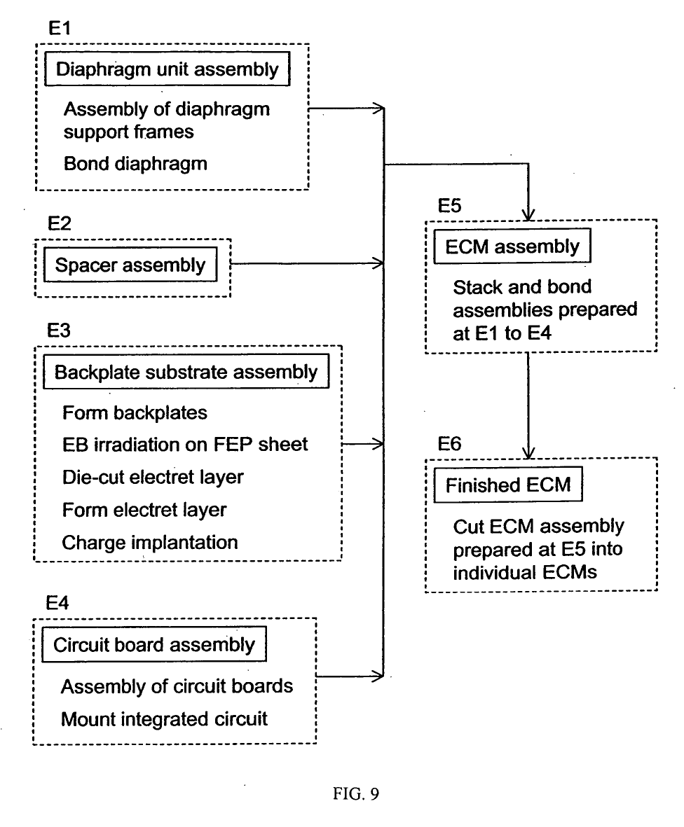

FIG. 9 is a process flow chart showing a method of producing an electret condenser microphone using component assemblies, which illustrates a third embodiment of the present invention.

The process shown in FIG. 9 is the same as that shown in FIG. 8 in regard to step E1 of producing the diaphragm unit assembly 7L, step E2 of producing the spacer assembly 6L, step E4 of producing the circuit board assembly 2L, step E5 of producing the microphone assembly 1L, and step E6 of producing finished electret condenser microphones. The process of FIG. 9 differs from that of FIG. 8 only in step E3 of producing the backplate substrate assembly 3L. That is, step E3 of producing the backplate substrate assembly 3L in the third embodiment takes into account the deformation of the electret layer due to the high temperature of the above-described radiation irradiation processing.

At step E3 of producing the backplate substrate assembly 3L shown in FIG. 9, only backplates are formed in advance on a backplate substrate assembly comprising an insulating substrate. Meanwhile, in the ionizing radiation irradiation equipment, a sheet-shaped FEP prepared in a rolled state as an electret material is irradiated with about 10 kGy to 100 kGy of ionizing radiation in an atmosphere of 280° C. to 330° C., which is not lower than the crystalline melting point of the FEP, in the absence of oxygen, i.e. at an oxygen concentration not higher than 100 ppm, thereby changing the sheet-shaped FEP into a crosslinked modified fluororesin. At this time, the sheet-shaped FEP is softened and slightly deformed due to the high temperature of the EB irradiation processing. Therefore, a cooling period is provided to allow the sheet-shaped FEP to become stabilized in shape.

Next, the sheet-shaped FEP stabilized in shape is die-cut into each individual piece of FEP, which is then stacked on each backplate of the backplate substrate assembly to form an electret layer. Next, the backplate substrate assembly is loaded into the charge implantation equipment to implant an electric charge into the electret layer of the modified fluororesin, thereby completing a heat-resistant backplate substrate assembly 3L.

In a case where the electret material is previously subject to radiation irradiation processing as stated above, even if the electret layer is thermally deformed during the radiation irradiation processing, the deformed electret layer can be reshaped by performing die cutting after cooling. Therefore, the temperature of the EB irradiation processing can be raised slightly, i.e. to a temperature of 300° C. to 330° C.

As has been stated above, the heat-resistant charged resin material according to the present invention exhibits a minimal reduction in the implanted electric charge under high-temperature conditions and is therefore suitable for use as an electret layer of an electret condenser microphone that undergoes high-temperature mounting process, e.g. reflow process. It is also possible to form a nonwoven fabric from the heat-resistant charged resin material as prepared in the form of fibers and to use it as a filter of an air conditioner that is used under high-temperature conditions. When formed in a nonwoven fabric, the heat-resistant charged resin material has an increased surface area and hence exhibits a strong adsorbing power with regard to fine particles in air and exhaust gas. Therefore, the nonwoven fabric of the heat-resistant charged resin material can also be used as a dust-proof mask, a mask for pollenosis, etc.

In the foregoing description, two different production processes have been shown as embodiments of the method of producing an electret condenser microphone of the present invention. These production processes have respective advantages. According to the process shown in FIG. 8, radiation irradiation processing is performed on a backplate substrate assembly that is in a finished state. With this process, the size of the ionizing radiation irradiation equipment is only required to be large enough to accommodate the backplate substrate assembly. Therefore, the radiation irradiation processing can be performed in small-sized facilities, advantageously. According to the process shown in FIG. 9, a sheet-shaped electret material is subjected to radiation irradiation processing before being die-cut into pieces of electret layer. This process needs large-sized ionizing radiation irradiation equipment that can accommodate the electret material in a rolled state, but it is capable of high-speed processing and suitable for mass-production. Further, the process shown in FIG. 9 has the advantage that it is possible to raise the temperature of the radiation irradiation processing.

It should be noted that the present invention is not necessarily limited to the foregoing embodiments but can be modified in a variety of ways without departing from the gist of the present invention.

What is claimed is:

1. A method of producing a heat-resistant electrically charged resin material, comprising the steps of:
providing a fluororesin material;
irradiating said fluororesin material with ionizing radiation at a temperature not lower than a crystalline melting point of said fluororesin material in absence of oxygen, thereby changing said fluororesin material into a crosslinked modified fluororesin material; and
implanting an electric charge into said modified fluororesin material.

2. The method of claim 1, wherein said fluororesin material is one selected from the group consisting of polytetrafluoroethylene, fluorinated ethylene-propylene copolymer, and tetrafluoroethylene-perfluoroalkyl vinyl ether copolymer.

3. The method of claim 1, wherein said fluororesin material is in a form selected from the group consisting of sheet, film, or fibers.

4. The method of claim 1, wherein said fluororesin material is irradiated with 10 kGy to 100 kGy of ionizing radiation under conditions that a temperature is in the range of 280° C. to 330° C. and an oxygen concentration is not higher than 100 ppm.

5. The method of claim 4, wherein said modified fluororesin material is subject to electric charge implantation so as to carry a negative electric charge.

6. The method of claim 4, wherein said fluororesin material is a film layer formed on a substrate made of a material selected from the group consisting of a metal, a resin and a ceramic material.

7. An electret condenser microphone comprising an electret layer, wherein said electret layer is made of a heat-resistant electrically charged resin material, said resin material being prepared by implanting an electric charge into a modified fluororesin material crosslinked by irradiating a fluororesin material with ionizing radiation at a temperature not lower than a crystalline melting point of said fluororesin material in absence of oxygen.

8. The electret condenser microphone of claim 7, wherein said fluororesin material is one selected from the group consisting of polytetrafluoroethylene, fluorinated ethylene-propylene copolymer, and tetrafluoroethylene-perfluoroalkyl vinyl ether copolymer.

9. A method of producing an electret condenser microphone comprising a diaphragm, a spacer, an electret layer, and a backplate, said method comprising the steps of:
forming a resin layer of a fluororesin on said backplate;
irradiating said resin layer with ionizing radiation at a temperature not lower than a crystalline melting point of said fluororesin in absence of oxygen, thereby changing said resin layer into a crosslinked modified fluororesin layer; and
implanting an electric charge into said modified fluororesin layer to form said electret layer.

10. The method of claim 9, comprising the steps of:
providing an electric circuit board assembly in which a multiplicity of electric circuit boards comprising semiconductor and other electric elements mounted thereon are integrally arrayed in a matrix;
providing a backplate substrate assembly in which a multiplicity of backplate substrates each having said backplate are integrally arrayed in a matrix;
forming a resin layer of a fluororesin on each backplate of said backplate substrate assembly;
irradiating said resin layer with ionizing radiation at a temperature not lower than a crystalline melting point of said fluororesin in absence of oxygen, thereby forming a crosslinked modified fluororesin layer;
implanting an electric charge into said modified fluororesin layer to form said electret layer;
providing a spacer assembly in which a multiplicity of spacers are integrally arrayed in a matrix;
providing a diaphragm unit assembly in which a multiplicity of diaphragm support frames are integrally arrayed in a matrix and a diaphragm material is spread on one side thereof;
bonding these assemblies to form a stacked assembly; and
cutting said stacked assembly into individual electret condenser microphones.

11. The method of claim 9, comprising the steps of:
providing an electric circuit board assembly in which a multiplicity of electric circuit boards having semiconductor and other electric elements mounted thereon are integrally arrayed in a matrix;
providing a backplate substrate assembly in which a multiplicity of backplate substrates each having said backplate are integrally arrayed in a matrix;
irradiating a resin sheet of a fluororesin with ionizing radiation at a temperature not lower than a crystalline melting point of said fluororesin in absence of oxygen, thereby forming a crosslinked modified fluororesin sheet;
die-cutting said modified fluororesin sheet to form electret members;
placing said electret members on respective backplates of said backplate substrate assembly to form said electret layers;
implanting an electric charge into said electret layers;
providing a spacer assembly in which a multiplicity of spacers are integrally arrayed in a matrix;
providing a diaphragm unit assembly in which a multiplicity of diaphragm support frames are integrally arrayed in a matrix and a diaphragm material is spread on one side thereof;
bonding these assemblies to form a stacked assembly; and
cutting said stacked assembly into individual electret condenser microphones.

12. The method of claim 9, wherein said fluororesin is one selected from the group consisting of polytetrafluoroethylene, fluorinated ethylene-propylene copolymer, and tetrafluoroethylene-perfluoroalkyl vinyl ether copolymer.

13. The method of claim 9, wherein said fluororesin is irradiated with 10 kGy to 100 kGy of ionizing radiation under conditions that the temperature is in a range of 280° C. to 330° C. and an oxygen concentration is not higher than 100 ppm.
